(19) United States
(12) Patent Application Publication
(10) Pub. No.: US 2016/0148363 A1
(43) Pub. Date: May 26, 2016

(54) METHODS AND SYSTEMS FOR STRUCTURAL ANALYSIS

(71) Applicant: ESSESS, INC., Boston, MA (US)

(72) Inventors: Long Phan, Somerville, MA (US); Navrooppal Singh, Mullica Hill, NJ (US); Jonathan Jesneck, Enfield, CT (US)

(21) Appl. No.: 14/734,336

(22) Filed: Jun. 9, 2015

Related U.S. Application Data
(63) Continuation of application No. PCT/US2013/031554, filed on Mar. 14, 2013.

(51) Int. Cl. G06T 7/00; H04N 5/33; G06K 9/00

(52) U.S. Cl. CPC G06T 7/001; G06K 9/00791; G06K 9/00637; H04N 5/332; G06T 2207/10048; G06T 2207/20221; G06T 2207/30184

(57) ABSTRACT

The present disclosure provides systems and methods for analyzing a structure. A method for analyzing a structure comprises capturing a at least one set of images of the structure in at least one range of wavelengths of light with an image capture device mounted on a vehicle. The at least one set of images can be processed to provided at least one set of image data. The at least one set of image data can be combined with separate data to form a combined data set. The combined set of data can be analyzed to determine one or more properties of the structure.

### BACKGROUND

This application is a continuation of International application number PCT/US2013/031554 filed on Mar. 14, 2013, which is incorporated herein and made a part hereof by reference in its entirety and for all purposes.

As the cost of energy for heating rises, and awareness increases of the environmental impact of wasted energy, it may be desirable to survey an area for buildings that are poorly insulated or otherwise using energy inefficiently.

Methods for surveying thermal losses from buildings are available. For instance, an aerial thermal image of an area may be obtained, which may be inspected visually for signs of excessive heat loss. The image may be compared with a map of the area to identify the building from which the heat loss emanates. For example, a building that appears relatively cool in the image may be either well heated but well insulated, or under-heated and badly insulated.

### SUMMARY

While there are systems and methods presently available for surveying buildings, recognized herein are various limitations associated with such methods. For example, a thermal image alone may not provide information that is sufficient to accurately determine one or more properties of a structure, such as a commercial or residential building. Aerial approaches for acquiring thermal images may not provide an image quality or resolution that is adequate to determine the one or more properties of the structure. In addition, an aerial approach may not provide detail that is sufficient to assess structural defects in a structure. Recognized herein is therefore the need to more reliably identify structural parameters, such as, for example, energy efficiency of a structure, which may be dependent at least in part on thermal insulation characteristics of the structure.

The present disclosure provides methods, systems, and computer program products for analyzing the structural and energetic properties of structures, such as cabins, homes, apartment complexes, office buildings, warehouses, and the like. A manned or unmanned vehicle having a mounted image capture device can be driven through a street, road or other pathway containing or adjacent to the structure to be analyzed, and images are taken of the structure. Images can be taken and analyzed in a high-throughput manner, such that many buildings can be analyzed in a short time period. Images of the structure are taken in various ranges along the electromagnetic spectrum, including but not limited to the far-infrared band, mid-infrared band, the near-infrared band, and the visible-light band. These images can be analyzed to determine the one or more structural and energetic properties of the structure, including but not limited to energy consumption, energy leakage, the level of insulation, structural integrity, and structural degradation. Such analysis may typically be performed by combining the image data with data from various sources, such as public and private geographic information services (GIS) and demographic data, self-reported information from the homeowner, and manual energy audit information. A computer or computer system may then infer the structural and energetic properties of the structure using the combined data. With the structural and energetic properties of the structure determined, recommendations on how to improve the structure can be provided to the owner. Also, the provided high-throughput data gathering analysis provided herein can also facilitate more accurate and faster estimates of the consumption scores and total cost of ownership of various structures, including insurance costs, property values, property tax, and mortgage rates.

Systems and methods of the present disclosure can identify various structural parameters, such as, for example, poor insulation, energy efficiency, latent structural features, structural fitness (or lack thereof). In some situations, methods of the present disclosure can be employed to detect latent structural features, which can be used to assess energy efficiency.

An aspect of the present disclosure provides a method for analyzing a structure. A first set of images of a structure is captured in a first range of wavelengths (for example, 350 nm to 1.2 μm) with a vehicle mounted image capture device while the vehicle is moving. A second set of images of the structure in a second range of wavelengths (for example, 8 μm to 12 μm) is similarly captured. A single vehicle mounted capture device may capture images in both the wavelength ranges, or multiple image capture devices may be used. A single set of images may comprise at least one image. One or more properties of the structure are determined based on the captured first and second set of images. The one or more properties of the structure may comprise structural, heating, and energy information. And, the one or more properties may be determined by comparing the captured first and second set of images with a separate set of data to infer the structural, heating, and energy information. This separate set of data may comprise one or more of public geographic information service (GIS) data, private GIS data, demographic data, self-reported homeowner information, and manual energy audit information. One or more fixes and improvements may be suggested based on the determined properties.

Various structural properties may be determined based on the above steps. The structural, heating, and energy information determined may include one or more of a presence of insulation, a type and effectiveness of the insulation, a presence of vapor barriers, a presence of baseboard heaters, wear and tear of structural features, weathering of structural features, a presence of cracks, structural integrity, a presence of gas leaks, a presence of water leaks, a presence of heat leaks, a presence of roof degradation, a presence of water damage, structural degradation, sagging insulation, improperly installed insulation, defective insulation, thermal emissivity, a presence or fitness of windows, a presence or fitness of roofing material, a presence or fitness of cladding (e.g., siding, brick), R-value, and wetness (e.g., the degree of wetness). The one or more properties of the structure may comprise energy flux per leak, which may be computed based on the inferred structural, heating, and energy information. The one or more properties of the structure may also comprise an energy consumption rate of the structure. The energy consumption rate may be compared with a second energy consumption rate of the structure from an energy audit, utility data, or database information of the structure.

Another aspect of the disclosure provides a computer-implemented method for analyzing a structure. First set and second sets of images of a structure in a first and second range of wavelengths (e.g., 350 nm to 1.2 μm and 8 μm to 12 μm, respectively). These image sets are captured from a moving vehicle. A single image set may comprise at least one image. The first and second image sets are combined with a separate set of data to form a combined data set, which is analyzed to determine one or more properties of the structure. One or more fixes or improvements to the structure can be suggested based on the determined one or more properties. The one or more properties of the structure may comprise any one of the structure properties discussed above. The separate set of data may comprise any one of the information types discussed above.

Another aspect of the disclosure provides a system for analyzing a structure. The system comprises a vehicle mounted image capture device and a processor. The vehicle mounted image capture device has a first image capture element for capturing images in a first wavelength range and a second image capture element for capturing images in a second wavelength range, though in some cases the same image capture element may capture images in both ranges. The processor is configured for determining one or more properties of the structure based on a first and a second set of images captured by the image capture device. In many embodiments, the processor is remote from the vehicle mounted image capture device, and the vehicle mounted image capture device comprises a communications module for transmitting the first and second set of captured images to the processor, which then determines the properties of the structure. The one or more properties of the structure may comprise structural, heating, and energy information. And, the processor may be configured to determine the one or more properties of the structure by comparing the captured first and second set of images with a separate set of data to infer the structural, heating, and energy information. The one or more properties of the structure may comprise any one of the structure properties discussed above. The separate set of data may comprise any one of the information types discussed above.

Another aspect of the present disclosure provides computer program products stored on non-transitory computer-readable storage mediums for performing any of the methods disclosed herein. One or more steps of these methods may be omitted, modified, or supplemented without departing from the scope of the disclosure. Code stored on the non-transitory computer-readable storage medium may be configured to implement one or more of said steps.

An aspect of the present disclosure provides a method for analyzing a structure, the method comprising capturing a set of images of the structure in one or more ranges of wavelengths of light with an image capture device mounted on a vehicle. The set of images is captured while the vehicle is moving. With the aid of a computer processor, the set of images is processed to generate a set of image data. Next, the set of image data is combined with a separate set of data to form a combined data set. The combined data set is analyzed to determine one or more properties of the structure. In some examples, a set of images of the structure is captured with a vehicle mounted image capture device over a range of wavelengths including visible, near infrared (NIR), mid-wavelength infrared (MWIR) and long wavelength infrared (LWIR). Pose and structural information can be captured using time of flight ranging laser imaging detection and ranging (LIDAR) or radio detection and ranging (RADAR) sub-systems of the image capture device.

Another aspect of the present disclosure provides a method for analyzing a structure, the method comprising capturing a set of images of said structure in one or more ranges of wavelengths of light with an image capture device mounted on a vehicle, wherein the set of images is captured while the vehicle is moving; processing, with the aid of a computer processor, the set of images to generate a set of image data; combining the set of image data with a separate set of data to form a combined data set; and analyzing the combined data set to determine one or more properties of the structure.

Another aspect of the present disclosure provides a method for analyzing a structure, the method comprising capturing a first set of images of said structure in a first range of wavelengths of light with an image capture device mounted on a vehicle, wherein the first set of images is captured while the vehicle is moving; capturing a second set of images of the structure in a second range of wavelengths of light with the image capture device, wherein the second set of images is captured while the vehicle is moving; and calculating, with the aid of a computer processor, one or more properties of the structure based at least in part on the captured first and second set of images.

Another aspect of the present disclosure provides a computer-implemented method for analyzing a structure, the method comprising obtaining a first set of images of said structure in a first range of wavelengths, the first set of images being captured with the aid of a moving vehicle; obtaining a second set of images of the structure in a second range of wavelengths, the second set of images being captured with the aid of the moving vehicle; combining the first and second set of images with a separate set of data to form a combined data set; and analyzing the combined data set to determine one or more properties of the structure.

Another aspect of the present disclosure provides a system for analyzing a structure, the system comprising a vehicle mounted image capture device having a first image capture element for capturing a first set of images in a first wavelength range and a second image capture element for capturing a second set of images in a second wavelength range; and a computer processor programmed to determine one or more properties of the structure based on said first and second sets of images captured by the image capture device while the vehicle is moving.

Another aspect of the present disclosure provides machine-executable code that, upon execution by one or more computer processors, implements any of the methods above or elsewhere herein.

Another aspect of the present disclosure provides a system comprising a memory location comprising machine-executable code implementing any of the methods above or elsewhere herein, and a computer processor in communication with the memory location. The computer processor can execute the machine executable code to implement any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the claimed invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “FIG.” and “FIGs.” herein) of which:

FIG. 1A schematically illustrates a method for analyzing a structure, in accordance with various embodiments of the present disclosure;

FIG. 1B schematically illustrates another method for analyzing a structure, in accordance with various embodiments of the present disclosure;

FIG. 2 schematically illustrates an image capture device, in accordance with various embodiments of the present disclosure;

FIG. 3 schematically illustrates a system for acquiring data to analyze a structure, in accordance with various embodiments of the present disclosure;

FIG. 4 schematically illustrates a system for facilitating methods of the disclosure, in accordance with various embodiments of the present disclosure;

FIG. 5 shows a screenshot of an application (top), which displays homes adjacent to one another, and thermal images (bottom) associated with a home selected from the application;

FIG. 6 shows a screenshot of an application (top), which displays homes adjacent to one another, and thermal images (bottom) associated with a home selected from the application;

FIGS. 7-16 show example reports that can be generated by a system programmed to obtain sets of images from a house and analyze the sets of images;

FIG. 17 is a plot that shows a correlation between building model score and natural gas consumption score;

FIG. 18 shows a workflow for processing data.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “vehicle,” as used herein, refers to a road or ground-based vehicle, such as a car, truck, motorcycle, scooter, boat, ship, robot, or other ground-based machine. A vehicle can be a manned vehicle. As an alternative, a vehicle can be an unmanned (or autonomous) vehicle, such as a drone. In some example, a vehicle can travel along a dirt road, gravel road, asphalt road, paved road, or other type of road. As an alternative, a vehicle can travel along a waterway, such as a river or canal.

The term “set,” as used herein, generally refers to one or more. A set of images can include one or more images.

The term “structure,” as used herein, generally refers to a structure that may be suited to house or contain a user, equipment, or mechanisms. Examples of structures include cabins, homes, apartment complexes, office buildings, warehouses, and the like. A structure can be a commercial or residential structure.

The term “geolocation” (also “geo-location”), as used herein, generally refers to the real-world geographic location of an object. In some cases, geolocation can refer to the virtual geographic location of an object, such as in a virtual environment (e.g., virtual social network). A geolocation can be a geographical (also “geographic” herein) location of an object identified by any method for determining or approximating the location of the object. In some examples, the geolocation of a user can be determined or approximated using the geolocation of an object associated with the user, such as a mobile device is proximity to the user. The geolocation of an object can be determined using the manner in which a mobile device associated with the object communicates with a node. The geolocation of an object can be determined using node (e.g., wireless node, WiFi node, cellular tower node) triangulation. For example, the geolocation of a user can be determined by assessing the proximity of the user to a WiFi hotspot or one or more wireless routers. As another example, the geolocation of an object can be determined using a global positioning system (“GPS”), such as a GPS subsystem (or module) associated with a mobile device (e.g., GPS capabilities of an Apple® iPhone® or an Android® enabled device).

### Methods and Devices for Analyzing Structures

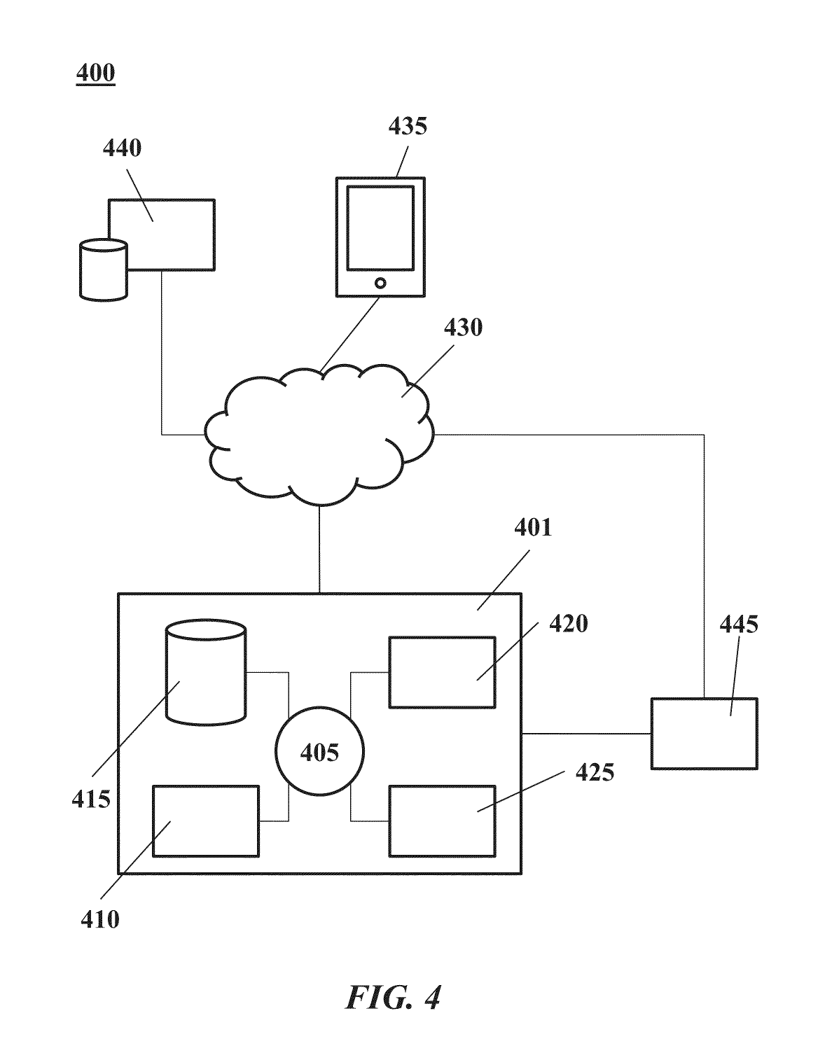

An aspect of the present disclosure provides a computer-implemented method for acquiring sets of images from a structure for analyzing the structure. The method can be implemented with the aid of a computer system (the “system”) having one or more computer processors, such as the sever 401 of FIG. 4.

A method for analyzing a structure comprises capturing a first set of images of the structure in a first range of wavelengths of light with an image capture device mounted on a vehicle, and capturing a second set of images of the structure in a second range of wavelengths of light with the image capture device. The first and second sets of images can be captured while the vehicle is moving. In some situations, the first and second sets of images can be captured while the vehicle is moving adjacent to the structure. With the aid of a computer processor, one or more properties of the structure can be calculated based on the captured first and second set of images. For example, the images can be digitized and analyzed to determine thermal losses and structural defects of the structure. The one or more properties can be calculated by i) combining the first and second sets of images with a separate set of data to form a combined data set, and ii) analyzing the combined data set to determine one or more properties of the structure.

The one or more properties of the structure can comprise structural, heating, and energy consumption information. In some situations, the one or more properties are determined by comparing the captured first and second set of images with a separate set of data to infer the structural, heating, and energy information. The separate set of data can include one or more of public geographic information service (GIS) data, private GIS data, demographic data, self-reported homeowner information, and manual energy audit information. The structural, heating, and energy consumption information can include one or more of a presence of insulation, a type and effectiveness of the insulation, a presence of vapor barriers, a presence of baseboard heaters, wear and tear of structural features, weathering of structural features, a presence of cracks, structural integrity, a presence of gas leaks, a presence of water leaks, a presence of heat leaks, a presence of roof corrosion (or degradation), a presence of water damage, structural degradation, thermal emissivity, a presence or fitness of windows, a presence or fitness of roofing material, a presence or fitness of cladding (e.g., siding, brick), R-value, and wetness.

In some situations, information gleaned from images captured by the image capture device can be combined with information gleaned from aerial images. The aerial images can include images of the structure imaged, which can identify defects and losses from locations of the structure that are not capable of being imaged from the image capture device onboard the vehicle. For example, aerial images can identify structural defects on a roof and/or chimney of the structure.

In some situations, the one or more properties of the structure can comprise energy flux per leak. The energy flux per leak can be computed based on the inferred structural, heating, and energy consumption information. The energy flux per leak can be used to determine a total energy flux of the structure. Conversely, from the total energy flux of the structure and an estimated energy flux per leak, a number of leaks can be estimated—e.g., the total energy flux can be divided by the energy flux per leak to get an estimate of the number of leaks in the structure.

The one or more properties of the structure can comprise an energy consumption rate of the structure. The first and second sets of images can be used to determine the rate at which energy is being used by the structure or dissipated from the structure. For instance, the first and second sets of images can be used to determine the rate at which heat is being generated in the structure, which can be used to determine an energy cost of the structure.

In some cases, with the aid of a computer processor, the energy consumption rate is compared with a second energy consumption rate of the structure or another structure (e.g., a neighboring structure, another similar structure). The second energy consumption rate can be determined as set forth above or elsewhere herein, or obtained from an energy audit or database containing information of or related to the second energy consumption rate.

The method can further comprise suggesting one or more fixes, remedial measures or improvements to the structure based on the determined one or more properties. For example, the server can suggest that a user having the structure fix one or more leaks or structural defects of the structure to, for example, decrease the rate of heat loss from the structure.

The first and second sets of images can be captured using imaging sensors that are tuned to the respective wavelengths of light. The sensors can be tuned to, for example, the infrared (IR) portion of the electromagnetic spectrum, the ultraviolet portion of the electromagnetic spectrum, or the visible portion of the electromagnetic spectrum. As an alternative, or in addition to, the image capture device can be configured for light detection and ranging laser imaging detection and ranging (LIDAR), radio detection and ranging (RADAR), detecting x-rays, and/or detecting electrons.

The image capture device can capture or detect at least 1, 2, 3, 4, 5, 6, 7, 8, 9, 10, 20, 30, 40, 50, 100, 200, 300, 400, 500, or 1000 sets of images. Each set of image can include one or more images. In some cases, a set of images includes images (e.g., still pictures) from a structure at various points in time. An image can be collected at a given wavelength of light or within a given range of wavelengths. In some examples, the first range of wavelengths can be in a range from 350 nm to 1.2 μm. The second range of wavelengths can be in a range from 8 μm to 12 μm. The image may or may not be visible to the eye of a user (e.g., human).

In some examples, the first range of wavelengths is within the visible and near infrared portion of the electromagnetic spectrum and the second range of wavelengths is within the far or long-wave infrared portion of the electromagnetic spectrum.

A set of images can include one or more images. Using an image capture device, a set of images can be captured from a structure in a time period of at most about 1 minute, 30 seconds, 20 seconds, 10 seconds, 5 seconds, 4 seconds, 3 seconds, 2 seconds, 1 second, 0.1 seconds, 0.01 seconds, 0.001 seconds, or less. A set of images can include one or more images. The time period can vary based on various parameters of the image capture device (e.g., shutter speed, exposure time), and based on the velocity of the vehicle. Data can be captured at a rate of at least about 0.1 frames (or images) per second (Hz), 1 Hz, 10 Hz, 100 Hz, 1000 Hz.

The image capture device can capture light of other wavelengths. For example, the image capture device can capture visible light.

The first set of images can be captured with a first image capture element of the image capture device and the second set of images is captured with a second image capture element of the image capture device. The second image capture element can be different from the first image capture element. Additional sets of images can be captured using additional image capture elements. An image capture element can be a sensor, such as an optical sensor (e.g., a sensor that is configured to generate an electrical signal upon exposure to a given wavelength of light).

The structure can be a building, a vehicle, a processing element (e.g., pipe, storage tank, unit operation), or a mechanical device. The structure can be a housing of another structure. In some examples, the structure is a building selected from a residential building and a commercial building.

Sets of images can be captured simultaneously by the image capture device. For example, the first and second sets of images are captured simultaneously. As an alternative, sets of images are captured after one another. For example, the first set of images is captured first, and the second set of images is captured after the first set of images. Additional sets of images can be captured sequentially after one another.

The first and second sets of images can be captured while the vehicle is moving adjacent to the structure. In some situations, the vehicle is directed adjacent to the structure prior to capturing images, such as prior to capturing the first set of images, the second set of images, or the first and second sets of images. For instance, the sets of images can be captured while the vehicle is moving by the structure at a velocity of at least about 0.1 miles/hour (MPH), 1 MPH, 2 MPH, 3 MPH, 4 MPH, 5 MPH, 10 MPH, 20 MPH, 25 MPH, 30 MPH, 35 MPH, 40 MPH, 50 MPH, 60 MPH, 70 MPH, 80 MPH, 90 MPH, or 100 MPH. The velocity of the vehicle between structure can be increase, for example, to reduce the time required to collect images from multiple structures. For instance, the vehicle can be moving along a road to image a first structure and a second structure down the street from the first structure. The vehicle can be travelling at 5 MPH while the first structure is imaged. Subsequent to imaging the first structure, the vehicle can increase its speed to 25 MPH to approach the second structure. The vehicle can then slow down to 5 MPH to image the second structure.

In some examples, the first and second sets of images are captured while the vehicle is moving on the ground. The ground can include a substantially level surface or a curvy surface with various elevations. The image capture device can be configured to adjust a plane of image capture to match the degree of tilt of the image capture device with respect to ground. For example, if the vehicle has tilted 5° towards the west, then the image capture device can tilt 5° towards the east to compensate for the tilt. Alternatively, the tilt of the image capture system can be corrected algorithmically via a computer system programmed to correct the tilt. The tilt can be measured with the aid of a gyroscope or an accelerometer of the image capture device or other system onboard the vehicle.

Methods of the present disclosure can be used to analyze structural losses, such as, for example, structural characterization, quantification, and ranking of losses from a structure. For instance, gas energy losses can be ranked higher than vapor losses, and such ranking can be used to set the order in which the losses are addressed (e.g., energy losses are addressed first). Such methods can be used to identify leaks, such as fluid leaks, gas leaks, and energy leaks.

Methods provided herein can be used for latent structural analysis, such as the analysis of structural degradation, roof corrosion, water damage, structural integrity. Methods above or elsewhere herein may be used for latent structural feature detection, such as, e.g., stud spacing, insulation (e.g., type, R-value, installation quality), presence of a vapor barrier, identification of heater type (e.g., central, baseboard, radiator).

Methods of the present disclosure can capture images from at least about 100, 500, 1,000, 2,000, 3,000, 4,000, 5,000, 6,000, 7,000, 8,000, 9,000, 10,000, 50,000, 100,000, 200,000, 300,000, 400,000, 500,000, or 1,000,000 or more structures per vehicle (e.g., car) per month. Image capture can be coupled with image processing.

An image can be processed as described elsewhere herein, such as, for example, as described in Examples 4-8. In some examples, captured images from a structure are used to calculate a relative heat loss of the structure. A set of images of the building are captured with the aid of an image capture device mounted on a vehicle. In each captured image, the background can be filtered to retain a portion of image that contains the structure. The average brightness (or intensity) of the image is then calculated, and the image can be digitized and processed to provide, for example, a temperature at various points along the image.

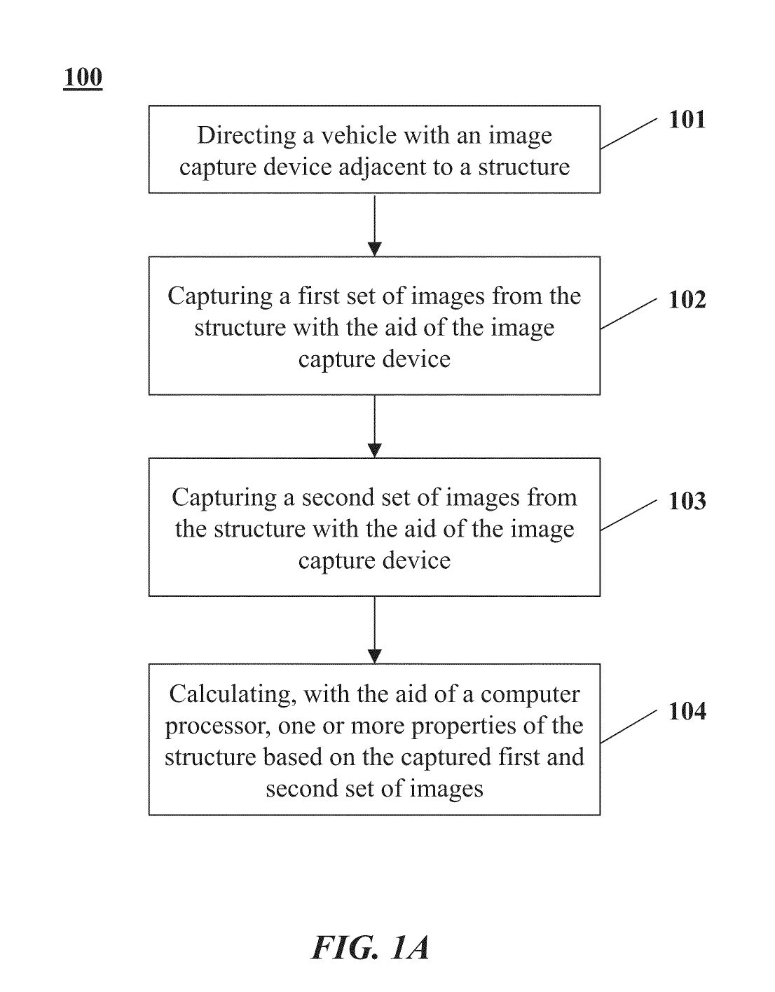

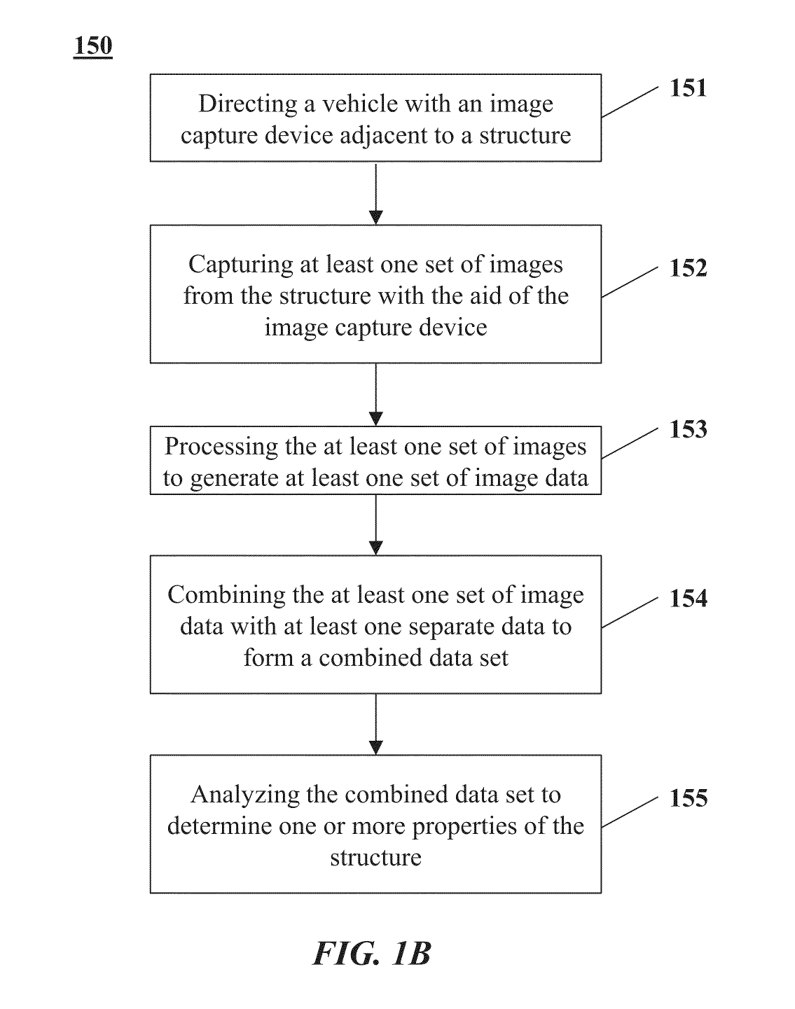

FIG. 1A schematically illustrates a method 100 for analyzing a structure (e.g., building). In a first operation 101, a vehicle with an image capture device is directed adjacent to a structure, such as, for example, a building. Next, in a second operation 102, a first set of images is captured from the structure with the aid of an image capture device. Next, in a third operation 103, a second set of images is captured from the structure with the aid of an image capture device. The first set of images and the second set of images can be captured simultaneously or sequentially (i.e., one after the other). In a fourth operation 104, one or more properties of the structure are then calculated based on the captured first and second set of images.

Image data capture from a structure can be combined with separate data. Separate data can comprise one or more of public geographic information service (GIS) data, private GIS data, demographic data, self-reported homeowner information, and manual energy audit information.

FIG. 1B schematically illustrates another method 150 for analyzing a structure (e.g., building). In a first operation 151, a vehicle with an image capture device is directed adjacent to the structure. In a second operation 152, at least one set of images is captured from the structure with the aid of the image capture device. The at least one set of images can be in one or more ranges of wavelengths of light. The at least one set of images can be captured while the vehicle is moving. Next, in a third operation 153, the at least one set of images is processed to generate at least one set of image data. The at least one set of images can be processed using a computer processor. In a fourth operation 154, the at least one set of image data is combined with at least one separate data (e.g., GIS data, private GIS data, demographic data, self-reported homeowner information, or manual energy audit information) to form a combined data set. Next, in a fifth operation 155, the combined data set is analyzed to determine one or more properties of the structure. The combined data set can be analyzed by computing a correlation between one or more individual images of the combined data and the at least one separate data, and analyzing the at least one set of image data based on the correlation.

In another aspect, a system for analyzing a structure comprises a vehicle mounted image capture device having a first image capture element for capturing a first set of images in a first wavelength range and a second image capture element for capturing a second set of images in a second wavelength range. The system further comprises a computer processor programmed to determine one or more properties of the structure based on the first and second sets of images captured by the image capture device while the vehicle is moving.

The image capture device can capture or detect at least 1, 2, 3, 4, 5, 6, 7, 8, 9, 10, 20, 30, 40, 50, 100, 200, 300, 400, 500, or 1000 sets of images. Each set of image can include one or more images. In some cases, a set of images includes images (e.g., still pictures) from a structure at various points in time. An image can be at a given wavelength of light or within a given range of wavelengths. In some examples, the first range of wavelengths can be in a range from 350 nm to 1.2 μm. The second range of wavelengths can be in a range from 8 μm to 12 μm.

The computer processor can be located remotely with respect to the vehicle mounted image capture device. The vehicle mounted image capture device can comprise a communications interface for transmitting the first and second sets of captured images to the computer processor for determining the one or more properties of the structure.

The material or property cost of a building or structure may not be the total cost of the structure. Other factors, such as energy factors, cost of living at the structure, and cost of travelling to and from the structure, may impact the overall (or total) cost of ownership.

Methods of the present disclosure can be used for high-throughput efficiency and comfort scoring. This can be used to estimate a total consumption score and total cost of ownership of a structure, which can, for example, increase the accuracy of insurance, property value, tax, and mortgage estimates.

Methods of the present disclosure can help identify, calculate, quantify and also improve homeowner comfort and building energy efficiency. In some examples, captured images can be augmented and analyzed with additional data to produce a custom, confidential report that identifies ways to improve comfort, lower interior noise pollution, reduce the ability of adulterants (e.g., allergens, mold, pollens and so on) to enter the home, and reduce energy bills. The report can be provided to a user on a user interface of an electronic device of the user, such as a web-based user interface or a graphical user interface. The report can include one or more offers and/or advertisements with incentives (e.g., product or service discounts) to enable the user to take advantage of offers that may be available to enable the user to make improvements to a structure of the user, such as a home.

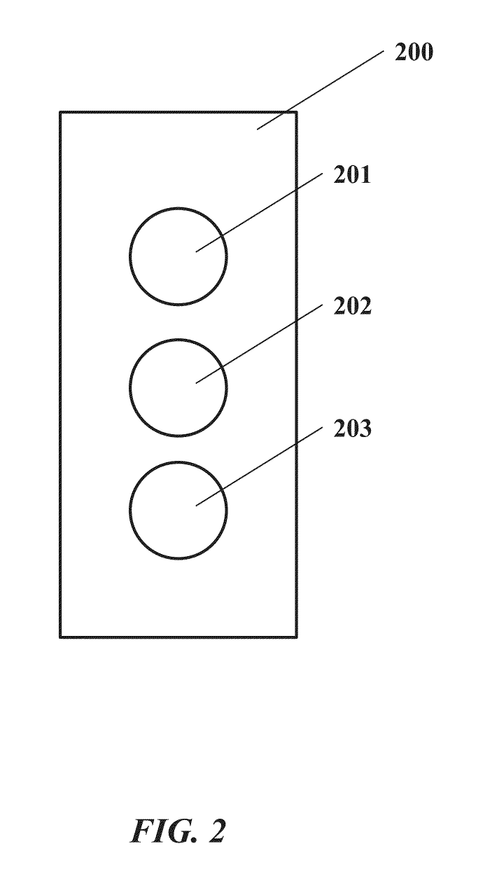

FIG. 2 shows an image capture device 200. The device 200 comprises a first sensor 201 for detecting light at a first wavelength or range of wavelengths, a second sensor 202 for detecting light at a second wavelength or range of wavelengths, and a third sensor 203 for detecting light at a third wavelength or range of wavelengths. The sensors 201, 202 and 203 are configured to detect different wavelengths or wavelength ranges of light. The device 200 can comprise more or fewer sensors. The device 200 can include one or more cameras, and each camera can include one or more sensors. A camera of the device 200 can include at least 1, 2, 3, 4, 5, 6, 7, 8, 9, 10, 20, 30, 40, 50, 100, 200, 300, 400, 500, 1000, 10,000, 100,000, 1,000,000, or more sensors. Multiple sensors can be provided in an array of sensors. The sensors can have various shapes, configurations and distributions. In some cases the sensors are distributed in a sensor array, such as a square array.

A data collection system can include an image capture device mounted on a vehicle. The vehicle can move adjacent to a structure, and the image capture device can collect one or more sets of images from the structure.

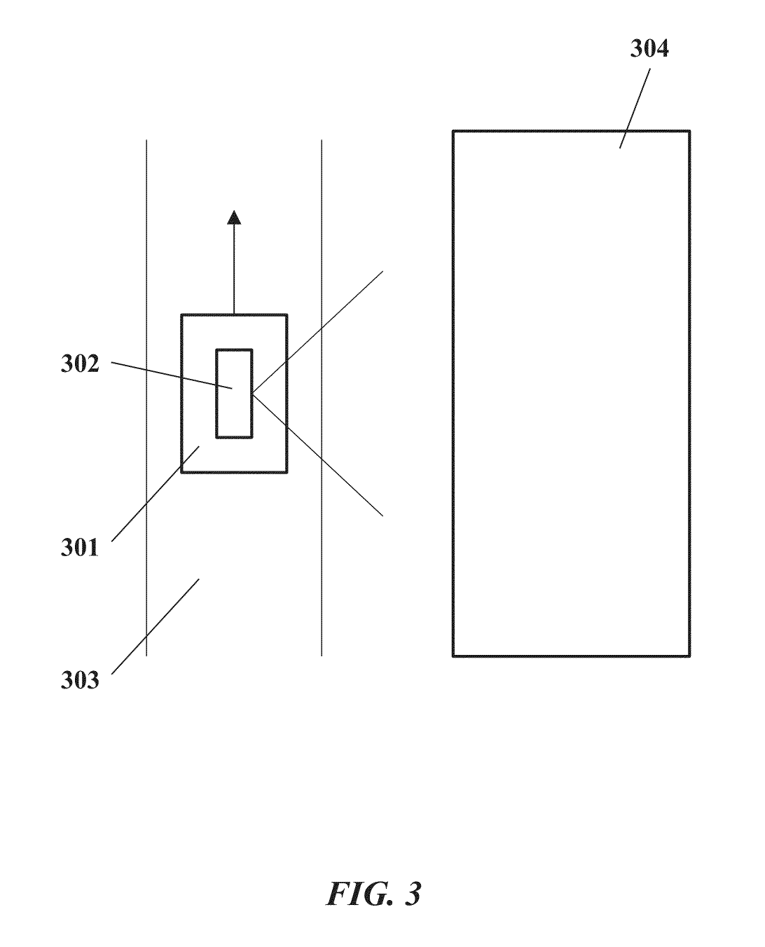

FIG. 3 schematically illustrates a method for analyzing a structure. A vehicle 301 comprising an image capture device 302 (e.g., the device 200 of FIG. 2) is moving along a road 303 adjacent to a building 304. The vehicle 301 is moving along the direction of the arrow. As the vehicle 301 moves along the road 303, the vehicle captures one or more sets of images from the building 304. An individual set of the one or more sets of images can include at least one image. The images can be subsequently processed with the aid of a computer processor to provide data for analyzing the building 304.

### Systems for Analyzing Structures

Another aspect of the present disclosure provides a system that is programmed or otherwise configured to implement the methods of the present disclosure. The system can include a computer server that is operatively coupled to an image capture device, in addition to an electronic device of a user.

FIG. 4 shows a system 400 programmed or otherwise configured to analyze a structure. The system 400 includes a computer server (“server”) 401 that is programmed to implement methods disclosed herein. The server 401 includes a central processing unit (CPU, also “processor” and “computer processor” herein) 405, which can be a single core or multi core processor, or a plurality of processors for parallel processing. The server 401 also includes memory 410 (e.g., random-access memory, read-only memory, flash memory), electronic storage unit 415 (e.g., hard disk), communication interface 420 (e.g., network adapter) for communicating with one or more other systems, and peripheral devices 425, such as cache, other memory, data storage and/or electronic display adapters. The memory 410, storage unit 415, interface 420 and peripheral devices 425 are in communication with the CPU 405 through a communication bus (solid lines), such as a motherboard. The storage unit 415 can be a data storage unit (or data repository) for storing data. The server 401 can be operatively coupled to a computer network (“network”) 430 with the aid of the communication interface 420. The network 430 can be the Internet, an internet and/or extranet, or an intranet and/or extranet that is in communication with the Internet. The network 430 in some cases is a telecommunication and/or data network. The network 430 can include one or more computer servers, which can enable distributed computing, such as cloud computing. The network 430, in some cases with the aid of the server 401, can implement a peer-to-peer network, which may enable devices coupled to the server 401 to behave as a client or a server.

The storage unit 415 can image data (e.g., sets of one or more images from an imaged structure) and one or more properties of a structure. The storage unit 415 can store data relating to a structure or an area comprising structures, such as energy usage data, maps (e.g., aerial map, street map), tax data and utility data. The server 401 in some cases can include one or more additional data storage units that are external to the server 401, such as located on a remote server that is in communication with the server 401 through an intranet or the Internet.

The server 401 can communicate with one or more remote computer systems through the network 430. In the illustrated example, the server 401 is in communication with a first computer system 435 and a second computer system 440 that are located remotely with respect to the server 401. The first computer system 435 and the second computer system 440 can be computer systems of a first user and second user, respectively, each of which may wish to view one or more properties of a structure. The first computer system 435 and second computer system 440 can be, for example, personal computers (e.g., portable PC), slate or tablet PC's (e.g., Apple® iPad, Samsung® Galaxy Tab), telephones, Smartphones (e.g., Apple® iPhone, Android-enabled device, Blackberry®), or personal digital assistants. The first and/or second users can access the server 401 via the network 430 to, for example, view one or more properties of the structure.

In some situations, the system 400 includes a single server 401. In other situations, the system 400 includes multiple servers in communication with one another through an intranet and/or the Internet.

The server 401 can be adapted to store structure (e.g., building) profile information, such as, for example, one or more properties of a structure (e.g., building). The server 401 can store properties of a structure, such as structural, heating, and energy information (e.g., energy consumption information), and other data, such as public geographic information service (GIS) data, private GIS data, demographic data, self-reported homeowner information, and manual energy audit information. The structural, heating, and energy information can include one or more of a presence of insulation, a type and effectiveness of the insulation, a presence of vapor barriers, a presence of baseboard heaters, wear and tear of structural features, weathering of structural features, a presence of cracks, structural integrity, a presence of gas leaks, a presence of water leaks, a presence of heat leaks, a presence of roof corrosion, a presence of water damage, structural degradation, thermal emissivity, a presence or fitness of windows, a presence or fitness of roofing material, a presence or fitness of cladding (e.g., siding, brick), R-value, and wetness. The server 401 can store other properties of the structure, such as energy flux per leak.

Methods as described herein can be implemented by way of machine (or computer processor) executable code (or software) stored on an electronic storage location of the server 401, such as, for example, on the memory 410 or electronic storage unit 415. During use, the code can be executed by the processor 405. In some cases, the code can be retrieved from the storage unit 415 and stored on the memory 410 for ready access by the processor 405. In some situations, the electronic storage unit 415 can be precluded, and machine-executable instructions are stored on memory 410. Alternatively, the code can be executed on the second computer system 440.

The server 401 can be coupled to an image capture device 445. The image capture device may be as described above or elsewhere herein, such as, for example, the image capture device 200 of FIG. 2. The image capture device 445 can be as described elsewhere herein. The image capture device 445 can be configured to capture sets of images from structures at various wavelengths or ranges of wavelengths of light. In an example, the server 401 is in communication with the image capture device 445 by direct attachment, such as through a wired attachment or wireless attachment. As another example, the server 401 is in communication with the image capture device 445 through the network 430.

The code can be pre-compiled and configured for use with a machine have a processer adapted to execute the code, or can be compiled during runtime. The code can be supplied in a programming language that can be selected to enable the code to execute in a pre-compiled or as-compiled fashion.

Aspects of the systems and methods provided herein, such as the server 401, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards, paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The server 401 can be configured for data mining, extract, transform and load (ETL), or spidering (including Web Spidering where the system retrieves data from remote systems over a network and access an Application Programming Interface or parses the resulting markup) operations, which may permit the system to load information from a raw data source (or mined data) into a data warehouse. The data warehouse may be configured for use with a business intelligence system (e.g., Microstrategy®, Business Objects®). The system can include a data mining module adapted to search for media items in various source locations, such as email accounts and various network sources, such as social networking accounts (e.g., Facebook®, Foursquare®, Google+®, Linkedin®) or on publisher sites, such as, for example, weblogs.

Information, such as one or more properties of a structure, can be presented to a user (e.g., buyer or seller) on a user interface (UI) of an electronic device of the user. Examples of UI's include, without limitation, a graphical user interface (GUI) and web-based user interface. A GUI can a user to view one or more properties of a structure with graphical features that aid in visually identifying at least a subset of the one or more properties of the structure. The UI (e.g., GUI) can be provided on a display of an electronic device of the user. The display can be a capacitive or resistive touch display, or a head-mountable display (e.g., Google® Glasses). Such displays can be used with other systems and methods of the disclosure.

Methods of the disclosure can be facilitated with the aid of applications (apps) that can be installed on electronic devices of a user. An app can include a GUI on a display of the electronic device of the user. The app can be programmed or otherwise configured to perform various functions of the system, such as, for example, displaying one or more properties of a structure to a user.

The server 401 can be programmed or otherwise configured with machine learning algorithms, which may be used to identify structural defects and structural inefficiencies. In some situations, the server 401 can be trained to recognized structures without defects, and use those structures as baselines to identify structures with defects.

Systems of the present disclosure (e.g., the serve 401) can generate reports. Such reports can be displayed on an app on an electronic device of a user, or provided to the user on a physical medium. A report can include a summary of any structural defects and/or identify any losses associated with a structure of the user or a structure of interest to the user (e.g., a home of the user, a home of potential or planned purchase by the user). The report can also include a total cost of ownership associated with the structure (see below).

### Total Cost of Ownership

Another aspect of the present disclosure provides systems and methods for estimating the total cost of ownership of a structure (e.g., residential building, commercial building). A data collection device can include a vehicle having an image capture device. The image capture device can collect images from a structure while the vehicle moves by the structure. The images can be processed and combined with other data. The other data can include public and private municipal data, building inspection data and data that the owner or occupant (e.g., homeowner) may provide (e.g., home temperature, utility bills and energy consumption). The processed images and other data can be stored in a memory location of a system for estimating the total cost of ownership, such as the system 400 of FIG. 4 having the server 401.

With the aid of a server (e.g., server 401 of FIG. 4) of the system, the processed images together with the other data can be used to estimate one or more properties about the structure. In some cases, the material used to form the structure can be estimated by correlating a shape of the structure and loss information (e.g., as may be gleaned from the collected images) associated with the structure with that of known structures having known materials. For example, the server can determine whether the structure has a vapor barrier or determine the type of insulation of the structure. This can enable the server to recommend remedial measures to the user, such as the installation of a vapor barrier or a given type of insulation to decrease heat loss.

In some situations, the server can estimate physical, tangible qualities about the structure. Next, the server can estimate a fitness of items (e.g., whether a vapor barrier been installed correctly, whether insulation been installed correctly). Based on these features, the server can estimate an R-value of the total envelope of the structure (e.g., whether the structure is adequately insulated) and consumption and utility cost.

Upon determining a composition or makeup of the structure, the server can estimate a total cost of ownership of the structure. The total cost of ownership can be calculated from the value of the structure, the overall energy usage of the structure (e.g., within a given period of time), and in some cases other data, such as, for example, the cost of travelling to and from the structure. For example, it may be more expensive for a user to travel from a structure to a city if the structure is in a remote (or rural) location. Transportation cost can increase the total cost of ownership. In such a case, a rural structure may have a higher total cost of ownership than a structure located closer to the city.

The server can provide a user of the structure comparison information if a neighbor of the user or user located in a similar location has a comparable structure. For example, the server can provide the user with a total cost of ownership (TCO) for owning a home of the user, and provide the user a comparison of the user's TCO to the TCO of a neighbor of the user with a home similar to the user. The TCO of the neighbor can be estimated using systems and methods of the disclosure, including determining a makeup (or composition) of the home of the neighbor from captured images.

An estimate of TCO can be beneficial to various users. For example, a homeowner may want to know the TCO in order to make improvements to the home of the homeowner to decrease the TCO and, consequently, save money. TCO can also be useful for insurance, tax estimation, and mortgage estimation purposes.

### Building Safety and Revenue Protection

Methods and systems of the present disclosure can provide for revenue protection and utility consumption verification. For instance, sets of images captured from a structure in addition to separate data that may be collected relating to the structure can be used to verify utility consumption associated with the structure. For instance, from images collected from a structure, in some cases in addition to separate data, the server 401 can determine a projected utility cost of the structure. The server 401 can then compare the projected utility cost to the actual utility cost. If there is a discrepancy, the sever 401 can alert the user (e.g., homeowner, utility) of the discrepancy, and the user can subsequently take measures to rectify the discrepancy.

For example, a homeowner is paying $100/month for natural gas. From images collected from a home of the homeowner in addition to the average temperature at the time of the year, the server 401 determines that the average natural gas cost for the homeowner should be $75/month. The server 401 notifies the homeowner of the discrepancy, such as, for example, using a user interface of an electronic device of the homeowner. The server 401 can also recommend that the homeowner may want to have a gas meter of the homeowner inspected to make sure it is functioning properly.

As another example, a homeowner is paying $20/month for natural gas. From images collected from a home of the homeowner in addition to the average temperature at the time of the year, the server 401 determines that the average natural gas cost for the homeowner should be $75/month. The server 401 determines that it is unlikely that the homeowner's utility cost on a monthly basis is reflective of the actual utility usage of the homeowner. The server 401 notifies the utility of the discrepancy, such as, for example, using a user interface of an electronic device of the utility. The server 401 can also recommend that the utility may want to have a gas meter of the homeowner inspected to make sure it is functioning properly.

Utility consumption verification may involve collecting and analyzing images from multiple structures in a given area and calculating an average utility cost in the area. For instance, from five homes imaged in a neighborhood, the server 401 can calculate an average utility consumption of the homes. The actual utility consumption of a given home among the five homes can be compared against the average, and the homeowner of the given home can be notified if the utility consumption of the homeowner is above the average (e.g., as this may indicate that the home of the homeowner is not as efficient as other homes among the five homes).

Methods of the present disclosure may be used to assess building safety. For instance, images captured form a building may be analyzed and compared to images from similar buildings to determine whether the building is safe to occupy.

### Disaggregation of Structural and Behavioral Effects

Methods of the present disclosure can be used to disaggregate structural and behavioral effects on utility bills from collected images, in some cases together with other data. Methods of the present disclosure enable a user (e.g., homeowner) to determine what fraction (or portion) of a utility bill of the user is due structural parameters (e.g., defects in the structure, poor insulation, no vapor barrier) and what fraction of the utility bill of the user is due to the user's behavior (e.g., the user prefers to keep the structure warmer than other users in similar structures).

In some examples, using time varying imagery, images collected from the structure can be processed and compared to images collected from similar homes. The images can be collected with the aid of methods and system discussed elsewhere herein. The collected images can be correlated with additional data, such as (GIS) data, private GIS data, demographic data, self-reported homeowner information, and manual energy audit information. This can be used to estimate a living pattern of the user of the structure (e.g., homeowner), such as, for example, whether the homeowner went to a warmer city during the winter.

In some situations, the total consumption of energy in a structure (e.g., home) is a function of several factors, such as, for example, the baseline energy usage for keeping the structure at a given temperature (e.g., 25° C.) or within a given temperature range (e.g., 25° C. to 30° C.), and contribution from the user (e.g., the user's travel expenses in travelling to or from the home, the user's preferred temperature). The baseline energy usage can be a function of structural parameters of the structure, as described elsewhere herein.

In some situations, the system can generate a score and/or risk assessment for the user, which can be based on a separation (or disaggregation) of structural parameters from behavior. Behavior can include living behavior. The comfort score can be provided on a user interface of an electronic device of the user, such as on a graphical user interface of the user. The system can generate a comfort score, total cost of ownership (TCO) score and/or efficiency score. As an alternative, or in addition to, the system can generate an insurability risk or mortgage risk.

In some examples, the user interface can also display a comparison of the user's score or risk to that of other users, such as the user's neighbor(s). The system can also present to the user with a mean (or average) and/or median comfort score in an area (e.g., neighborhood, city) of the user. The system can provide a comparison of the user to similar homes, in some cases with similar demographics (e.g., family size), or a comparison of the user to homes with similar structure (e.g., 1920's farm homes). The system can inform the user as to which portion of the score or risk of the user is due to structural parameters and which portion is due to a behavior of the user.

### EXAMPLES

### Example 1

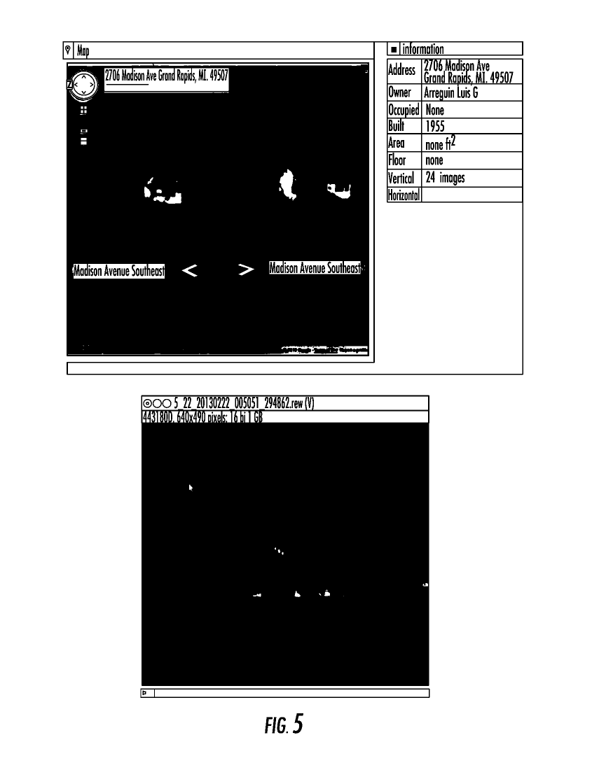

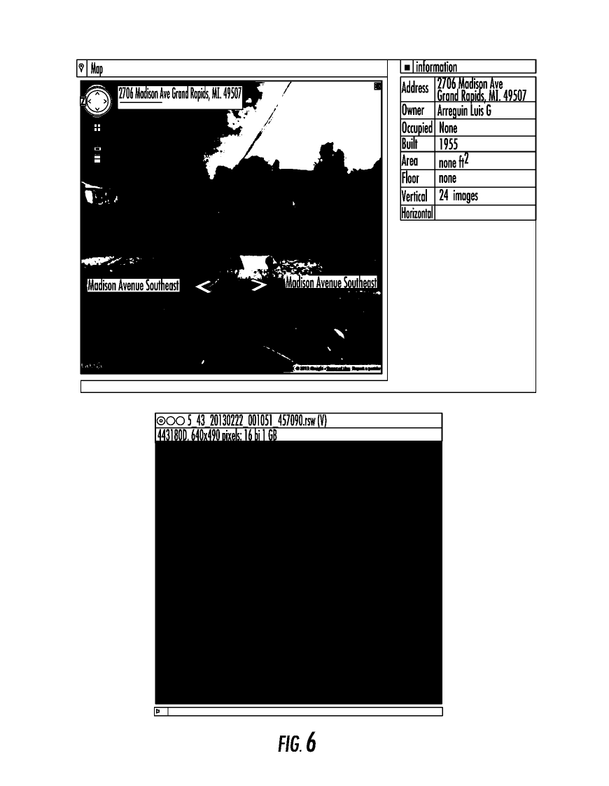

FIGS. 5 and 6 show screenshots of an app (top), which displays homes adjacent to one another. A user of the app has selected a home from the app. Upon selection, the app displays a thermal image of the home (bottom) to the user. Each app provides an address of the building and indicates that there are 24 vertical images associated with a given building.

### Example 2

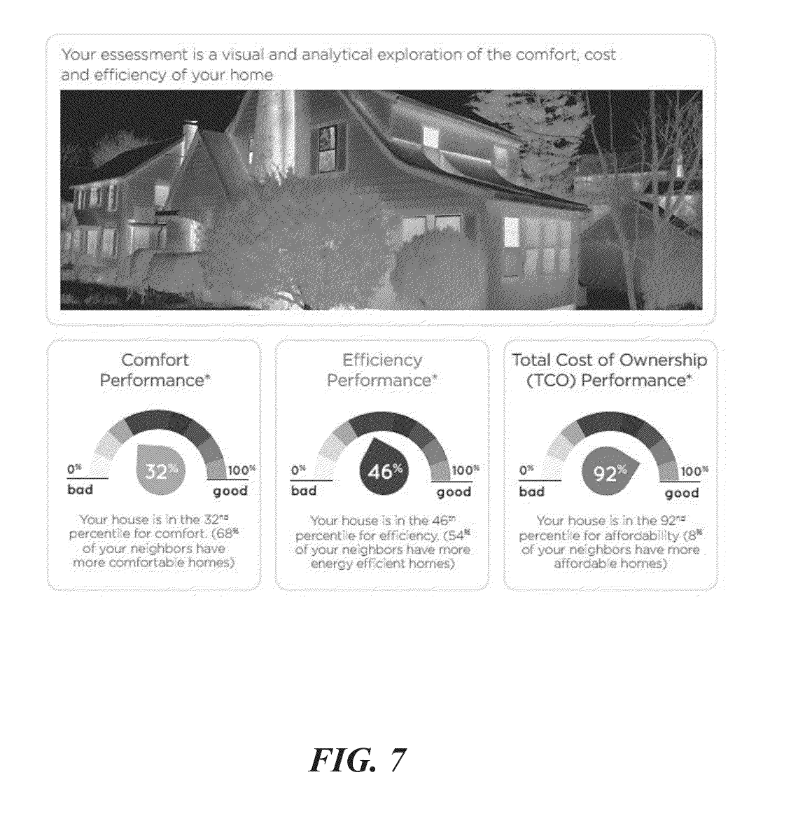

FIGS. 7-16 show example reports that can be generated by a system programmed to obtain sets of images from a house and analyze the sets of images. The system can be the server 401 of FIG. 4. The reports can be generated for a user, such as an owner of the house. The reports can be presented by way of an overall assessment of the house of the user.

FIG. 7 shows a thermal image of a home (top) and various metrics associated with the home. The metrics are derived by capturing sets of images from the home and processing the images along with separate data, as described elsewhere herein. The metrics include comfort performance (or score), efficiency performance, and total cost of ownership (TCO) performance, all of which are displayed as percentages or percentiles, with 0% being “bad” and 100% being “good.” The metrics can also include various risk scores, such as a score associated with an insurability risk or mortgage risk of the user. For the illustrated home, the comfort performance is 32%, efficiency performance is 46%, and TCO performance is 92%. The TCO performance indicates that the house is in the 92nd percentile for affordability. 8% of neighboring homes have more affordable homes.

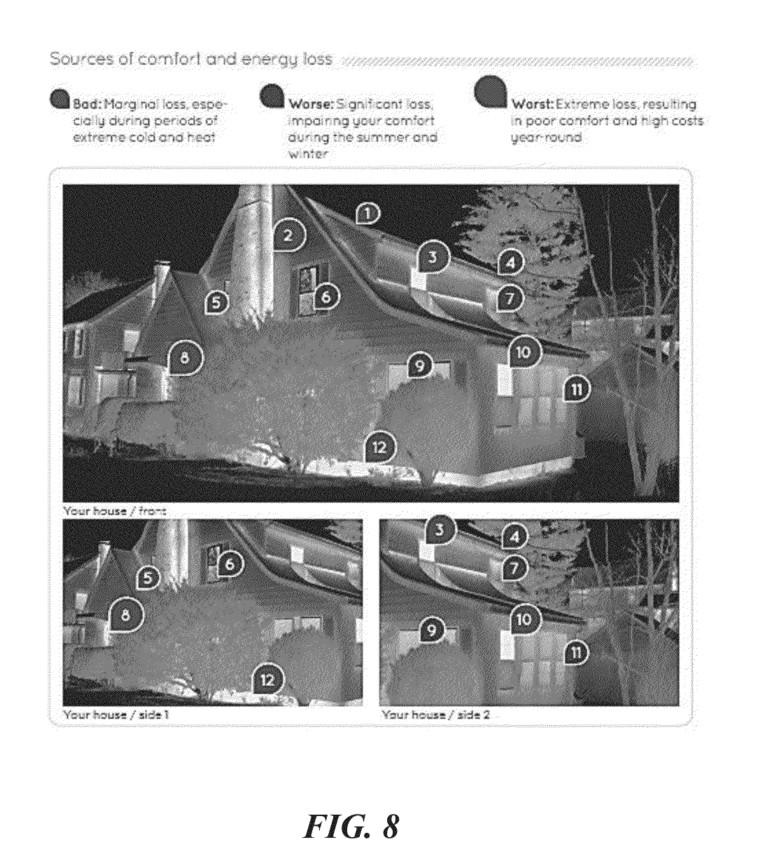

FIG. 8 shows the house of FIG. 7 with an identification of losses (e.g., heat losses, leaks) at various locations of the house (top image). The bottom two images show losses at a first side (bottom-left) and second side (bottom right) of the house. Locations in which losses are the worst are displayed in red balloons; locations in which losses are worse than other locations are displayed in purple balloons, and locations in which losses are bad are displayed in blue balloons. Losses that are categorized as worst may require immediate attention, as they are categorized by the system as “extreme loss.” Losses that are categorized as “worse” are significant losses, but not extreme losses—worse losses may be attended to after worst losses. Losses that are categorized as “bad” are marginal losses.

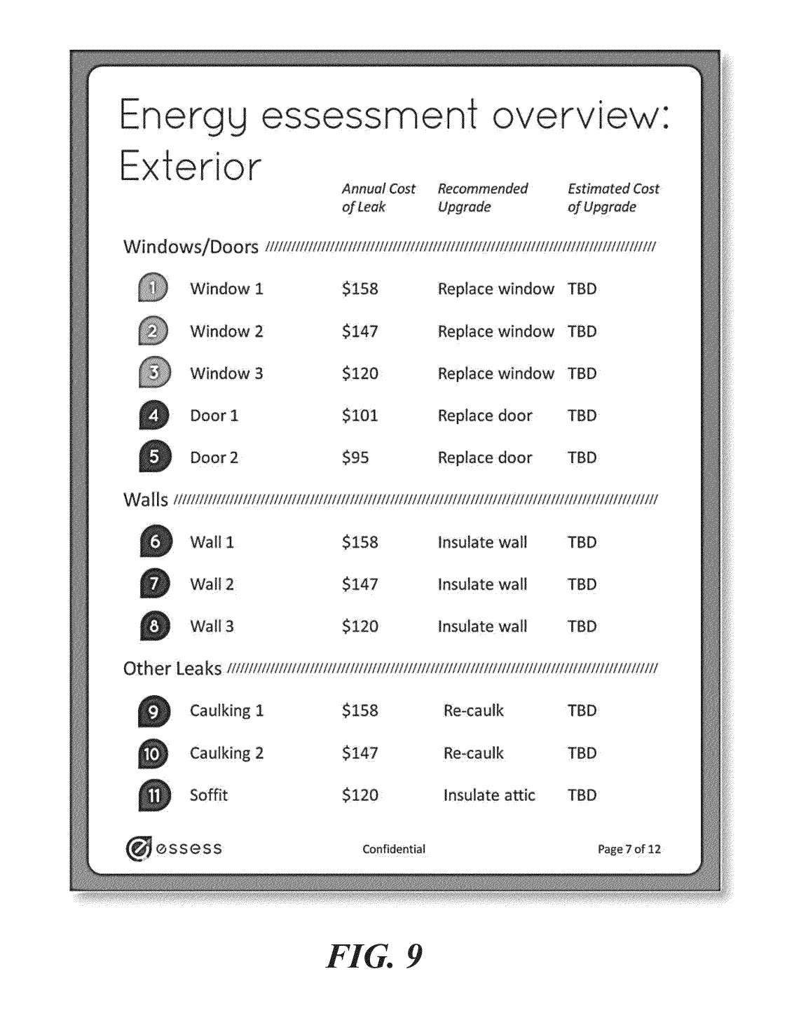

FIG. 9 is a report that is generated by the system to provide an energy assessment overview of the house of FIG. 7. For each loss identified in FIG. 8, the report provides an estimated annual cost associated with the loss. The report includes a recommended upgrade. For instance, the system recommends that the user replace the window. In some situations, the system can calculate an estimate cost for the upgrade and include that in the report. The report provides an assessment overview of looses associated with windows/doors (balloons 1-5 from the top), walls (balloons 6-8), and other leaks (balloons 9-11).

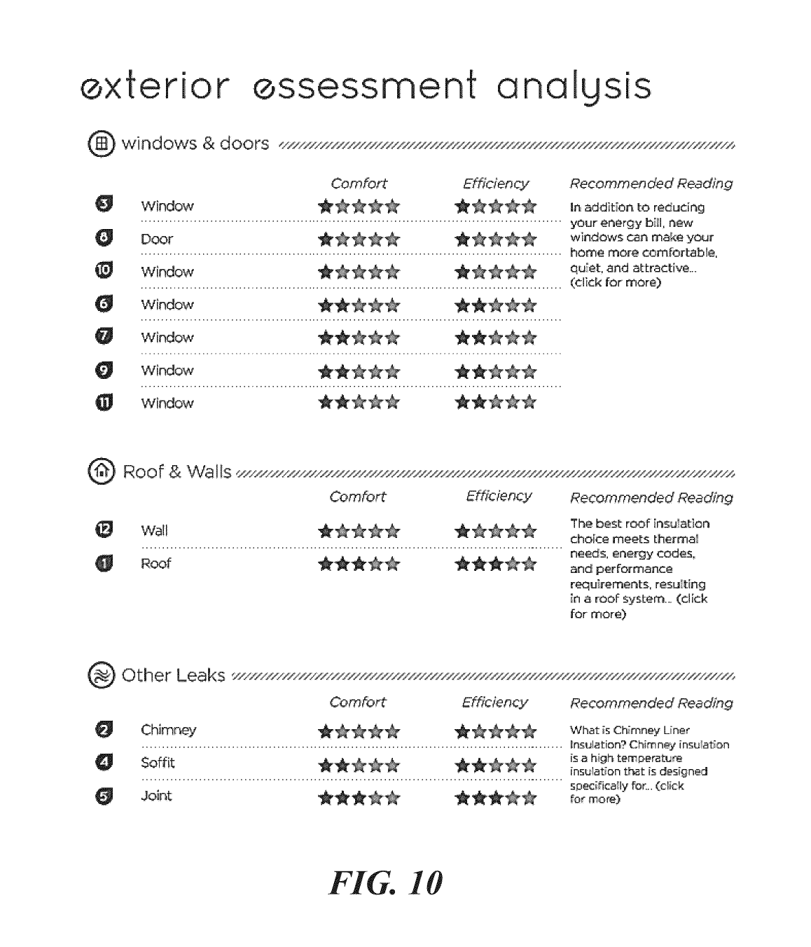

FIG. 10 shows an exterior assessment analysis associated with the house of FIG. 7. For all losses identified in FIG. 8, the analysis provides a comfort score and an efficiency score, which are displayed by a star rating out of five stars, with one star being a poor rating and five stars being a great rating. The losses are categorized by “Windows & Doors” (top group), “Roofs & Walls” (middle group), and “Other Leaks” (bottom group). The analysis also provides a recommended reading associated with each group of losses. For example, the loss associated with a window of the house (top row) has a one star rating under comfort and a one star rating under efficiency, which indicates that the window provides minimum comfort and is minimally efficient. Within each group, the losses are sorted by comfort and efficiency ratings, from worst rating to best rating.

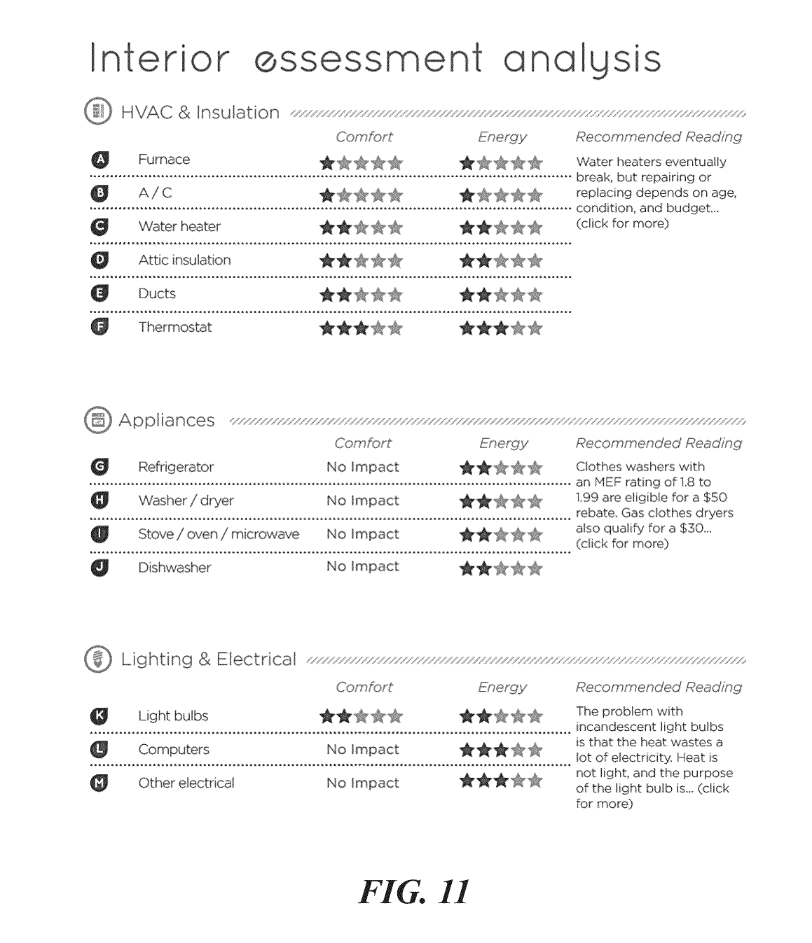

FIG. 11 shows an interior assessment analysis associated with the house of FIG. 7. For interior features (i.e., furnace, A/C, water heater, attic insulation, ducts, thermostat, refrigerator, washer/dryer, stove/oven/microwave, dishwasher, light bulbs, computers, and other electrical), the analysis provides a comfort score and an efficiency score, which are displayed by a star rating. The interior assessment can be determined by the system from an assessment of losses and other structural defects, in addition to separate data, related to the house. The interior assessment includes three groups, namely “HVAC & Insulation” (top group), “Appliances” (middle group), and “Lighting & Electrical” (bottom group). The analysis also provides a recommended reading associated with each group. For example, the furnace (top row) has a one star rating under comfort and a one star rating under efficiency. Within each group, the features are sorted by comfort and efficiency ratings, from worst rating to best rating.

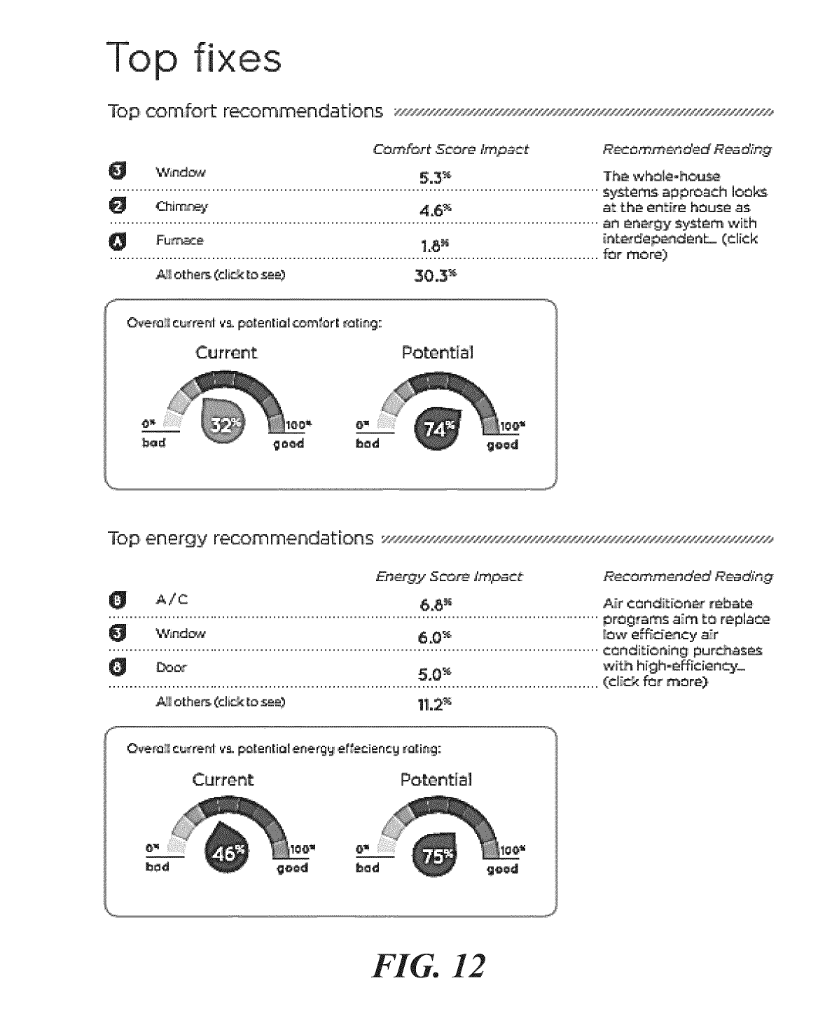

FIG. 12 is a report that identifies top fixes associated with the house of FIG. 7. The report of FIG. 12 provides the current comfort rating of the house (32%) and the potential comfort rating of the house (74%) if fixes were to be made. The report of FIG. 12 also provides the current energy efficiency rating of the house (46%) and the potential energy efficiency of the house (75%) if fixes were to be made. Under comfort rating (top block), the report of FIG. 12 identifies the top fixes that can be made (window, chimney and furnace), and the comfort score impact associated with each fix. Under energy efficiency (bottom block), the report identifies the top three fixes (A/C, window and door) that can be made to improve the energy efficiency of the house.

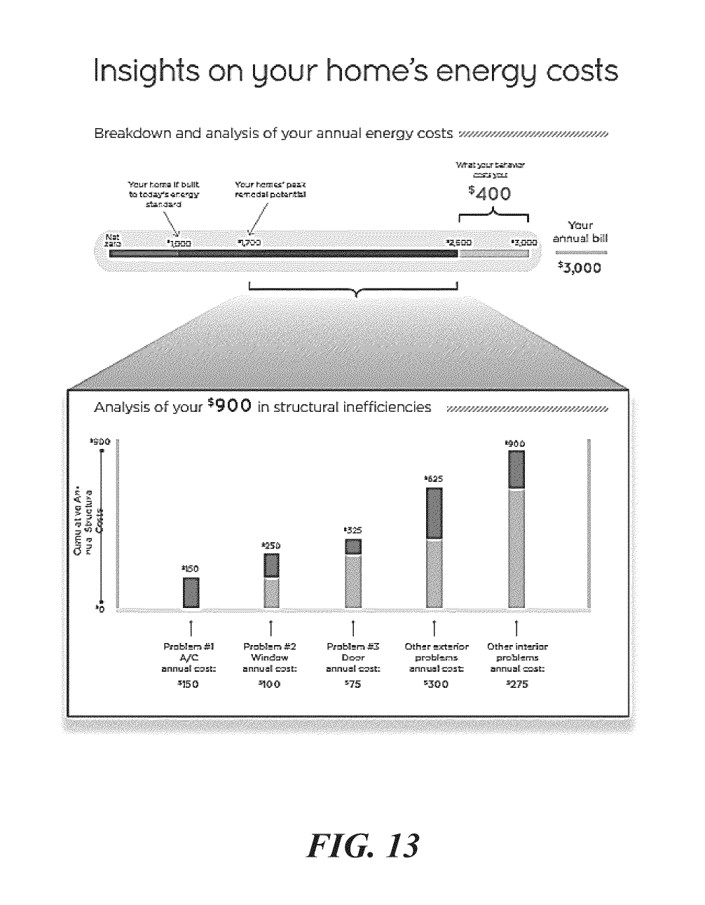

FIG. 13 is a report that provides insight into the energy cost associated with the house. The report identifies an annual bill for the energy cost of the house ($3,000). The report indicates that $400 of the annual bill is associated with a behavior of the user and other occupants of the house. The report indicates that $900 of the annual bill is due to structural inefficiencies, and in the bar plot (bottom) provides a breakdown of the inefficiencies. The five columns in the bar plot are corrections that can be made, which may save the user $900 annually.

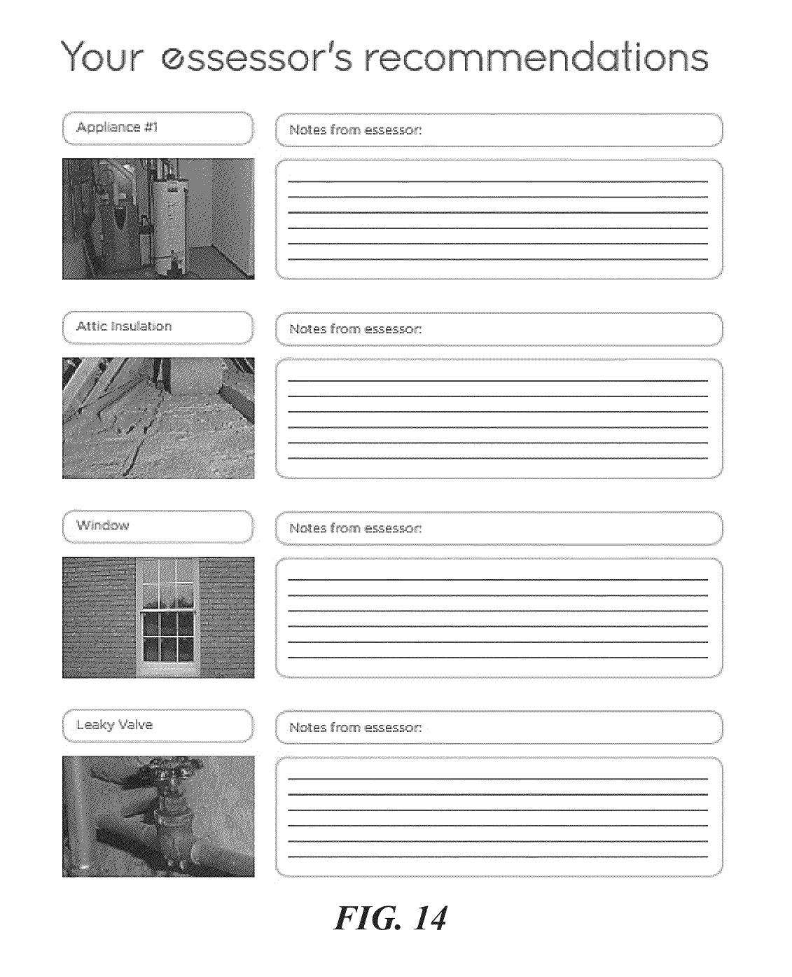

FIG. 14 shows recommendations for fixes that can be made to the house. The fixes include “Appliance #1,” “Attic Insulation,” “Window,” and “Leaky Valve.” The recommendations can include notes from an assessor.

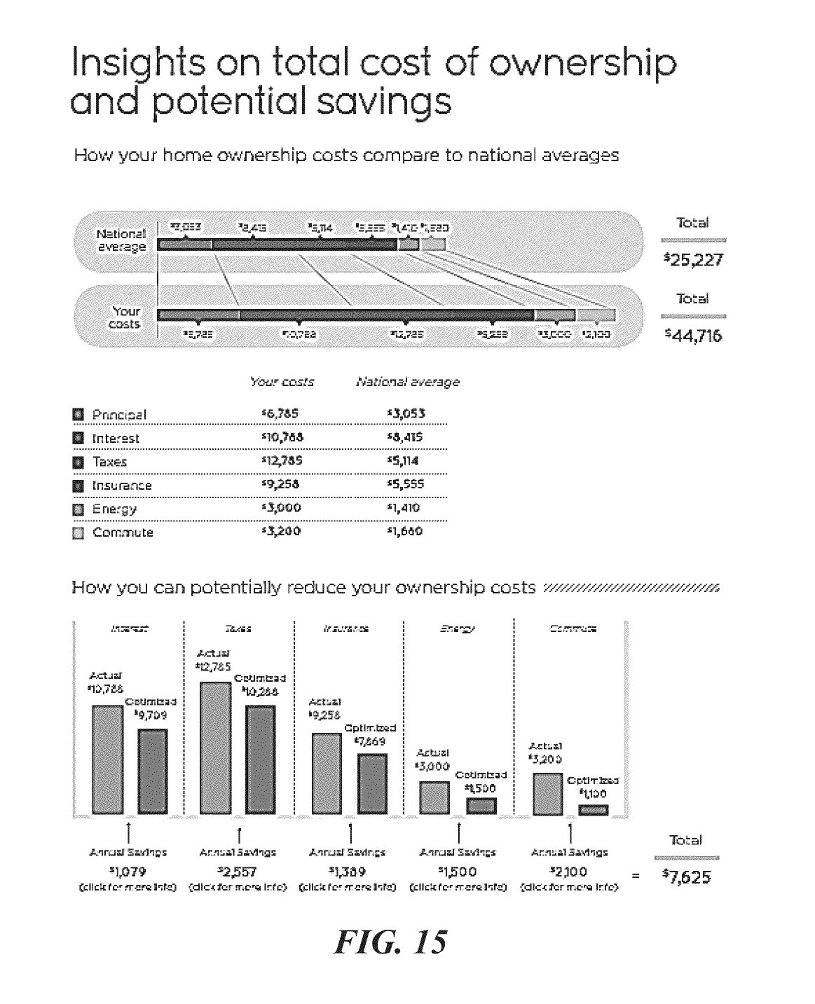

FIG. 15 is a report with insights on the total cost of ownership (TCO) and potential savings. The TCO takes into account the principal cost (“Principal), associated interest (“Interest”) and taxes (“Taxes”), insurance costs (“Insurance”), energy costs (“Energy”) and cost of commute (“Commute”). The TCO of the user ($44,716) is displayed against a national average ($25,227). The national average can be generated by comparing the house of the user to similar homes, in some cases in similar areas. A bottom portion of the report shows examples of approaches that the user can take to potentially reduce the TCO of the user. The approaches include minimizing interest, taxes, insurance, energy and commute. The report indicates that the user can potentially reduce the TCO by $7,625 on an annual basis.

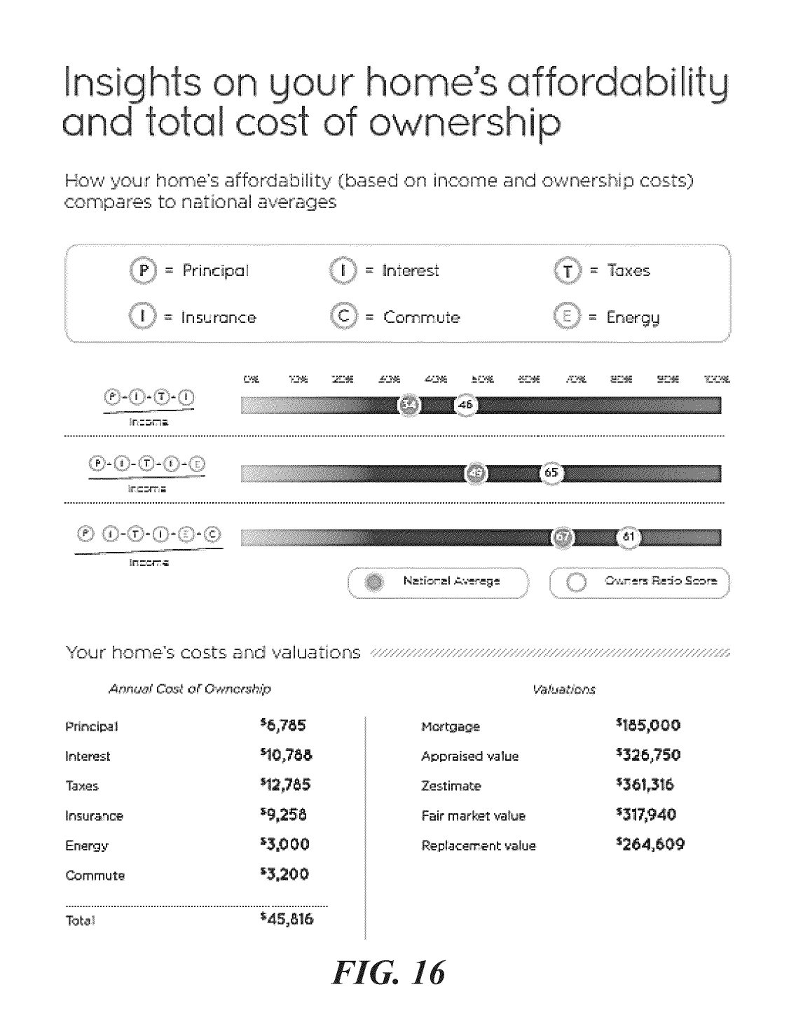

FIG. 16 is a report with insights on the affordability and total cost of ownership of the house. The report provides an overview of how the affordability of the house of the user (based on income and ownership costs) compares to the national average.

### Example 3

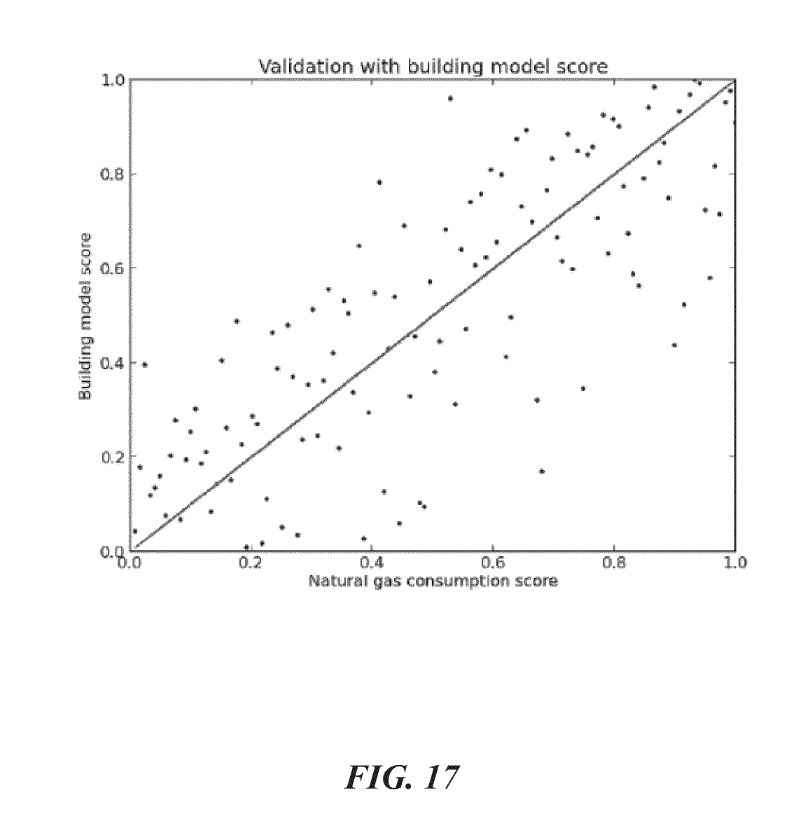

Structural data can be used to predict utility usage, which can be used to train systems for deriving utility usage from images collected from structures. For example, building data (e.g., living area) can be combined with a surface temperature of a house to draw a correlation between building data and surface temperature. FIG. 17 shows a correlation between a building model score (y-axis) and natural gas consumption score (x-axis). The correlation of FIG. 17 can be used to predict natural gas consumption for other buildings. For example, from sets of images collected from a building, a building score can be calculated that is a function of the size of the building and the temperature of the surface of the building. From the building score, FIG. 17 can be used to estimate a natural gas consumption score of the building.

### Example 4

An analysis system can be used to interpret the thermal cameras' images and translate them into a library of quantified energy issues. This interpretation process has several steps. First, for image preprocessing, the system uses thermal camera calibration data to translate the raw infrared images into radiometric images. Other preprocessing steps include lens de-warping (i.e., removing the lens curvature effects from the image), synthetic aperture imaging (i.e., stitching together images from multiple cameras, while compensating for different camera poses, and making the resulting high-resolution panorama appear to have been captured from a single camera), automated contrast optimization (i.e., adjusting the image contrast to focus in on the temperature range of interest), and scene radiation correction (i.e., using three dimensional scene geometry and detected radiation sources to distinguish emitted vs. reflected radiation, which would cause an object to appear erroneously hot).

After preprocessing, the system detects a building's energy issues through further image processing, computer vision, and machine learning. The system thresholds the temperature image by a minimum temperature to remove background detail and identify hotter regions of interest (ROIs) within the image. In each ROI, the system calculates multiple image features, such as corners, edges and thermal gradients, and texture patterns. These extracted image features form a rich description of the local information in each ROI. The system then feeds these features into a classifier, such as a support vector machine, to predict the most likely energy leak class: window, air draft at a window edge, poorly insulated wall, insulation sag, door, attic gable, basement wall, etc.

Once each energy issue receives a class label, the system calculates the leak severity using a physics-based modeling approach. The system calculates the temperature difference between the estimated indoor temperature and the recorded external air temperature. The temperature difference and the leak class' material properties allow the system to calculate the leak's R-value (i.e., the thermal resistance). With the R-values, the system constructs a heat-flow model to calculate the annual escaped energy through each leak, which is adjusted the by local climate's heating degree days and cooling degree days. The data about escaped energy (“negawatts”) are stored into the data library with each leak's other information.

With each energy leak quantified, the system performs both a micro-scale analysis per building and a macro-scale analysis per city. For the micro-scale building analysis, the system ranks each leak by severity and calculates a raw energy score for the building. For the macro-scale analysis, the system translates buildings' raw energy scores into relative percentiles. The system also tallies the leaks by leak type across the city, in order to compile a comprehensive energy report that describes and quantifies wasted energy across the city.

### Example 5

This example provides a process flow for leak detection, characterization, classification and severity ranking. In this example, images are captured from a structure (e.g., building) using an image capture device mounted on a vehicle, and directed to a computer system (e.g., server 401 of FIG. 4) for processing.

The server can process each image individually. Initially, an image can be pre-processed. This can include generating a temperature image from the raw image. Next, the system generates a threshold of the image by temperature to isolate hotter regions in a scene of the image from cooler regions. The system then calculates image features (e.g., corners, edges, thermal gradients, texture patterns), and provides the image features into a classifier, such as a support vector machine (SVM) to predict the most likely leak class (e.g., window, wall, door, attic, basement, etc.).

For each leak, the system calculates a leak severity. The system can calculate the R-value based on the temperature difference and material properties, and calculate the annual heat flow of the leak based on heating and cooling degree days. The system then ranks the leaks according to their severities in wasted energy, and calculates an energy score of the structure.

### Example 6

One of the most difficult aspects of building energy analysis is disaggregating the total energy usage into the behavioral component, such as thermostat settings, from the structural component, such as inadequate wall insulation. An energy analysis system of the present disclosure uses a probabilistic approach, which comprises calculating prior distributions on latent information (e.g., internal temperature) and subsequently, with a utility bill associated with the building, calculating the latent variables' most likely values.

The system creates a prior distribution of indoor air temperatures from previously reported thermostat settings for similar buildings. Building similarity is based on building type, architectural style, building age, building dimensions, occupancy level, and occupant demographics. HVAC system efficiency is similarly estimated from the above building characteristics, plus insulation properties and building envelope details that are visible from thermal imaging. The HVAC information can be modeled by extrapolating from neighboring and similar buildings that have HVAC information. The system combines these internal temperature and HVAC data with the building envelope information, as elsewhere herein. The system calculates the maximum a posteriori estimate for the latent variables of indoor temperature and HVAC equipment using the relationship

θ_{MAP}(t, hvac)=arg max_{t,hvac} f(utility|t, hvac),

where ‘θMAP’ is the maximum a posteriori (MAP) estimate of the latent variables, ‘t’ is the indoor temperature, ‘hvac’ is the HVAC equipment and efficiency rating, ‘utility’ is the recorded energy usage (e.g., utility bill), and f(utility|t, hvac) is the likelihood function for observing the energy usage given the indoor temperature and HVAC system. The system uses this statistical modeling to reverse engineer the most likely internal temperature setting and HVAC system. The MAP estimate allows the system to scale the magnitude of the wasted energy with the indoor temperature and HVAC system. With this information, the behavioral aspect (e.g., setting the thermostat) of energy consumption can be decoupled from the structural aspect (e.g., home insulation and energy efficiencies). The structural component is associated with the extra negawatts for the building envelope above the normal negawatts for an adequately weatherized building. The behavioral component is associated with the extra negawatts for temperatures more extreme than a standard thermostat setting, such as, for example, 65° F.

### Example 7

This example provides a process flow for disaggregating structure form behavioral components of structural energy use. In this example, images are captured from a structure (e.g., building) using an image capture device mounted on a vehicle, and directed to a computer system (e.g., server 401 of FIG. 4) for processing.

The server can process each image individually. The system estimates the distribution of likely internal temperature and the efficiency of any heating, ventilation, and air conditioning (HVAC) system. The system can detect and quantify building envelop issues as described elsewhere herein (see, e.g., Example 5). With such distributions, the system can scale negawatt magnitude and calculate the posterior distribution of internal temperature. Next, given a utility bill associated with the structure, the system can reverse engineer the most likely internal temperature setting and subsequently use this estimate to split the total energy usage associated with the structure into the structural component and the behavioral component (e.g., thermostat settings). The structural component can be associated with the extra negawatts for the building envelope above the normal negawatts for a properly weatherized building. The behavioral component can be associated with the extra negawatts for temperatures more extreme than a standard thermostat setting (e.g., 65° F.).

### Example 8

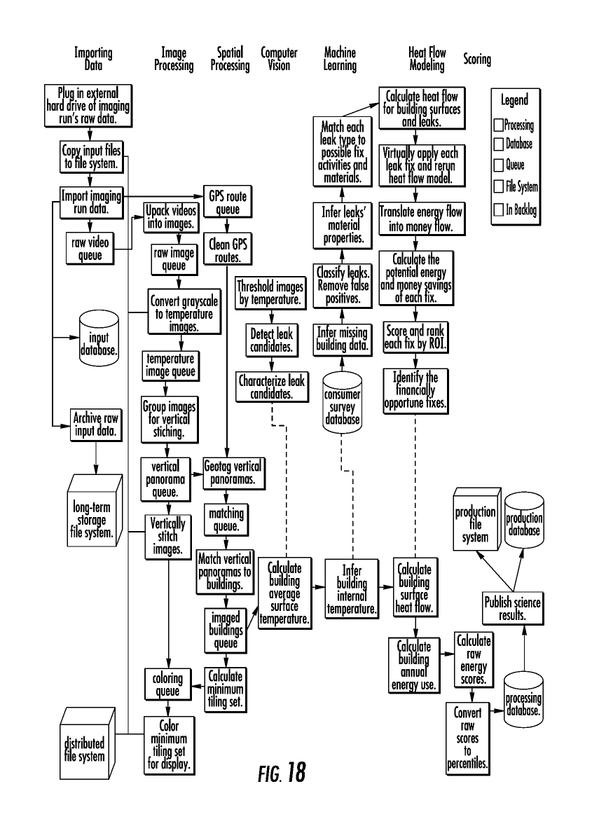

FIG. 18 shows a workflow for processing data. Initially, data (e.g., image data, video data) is imported from an electronic data storage location into a system for image processing. The images are the processed by unpacking any videos into images, converting grayscale images to temperature images, groping images for vertical stitching and vertically stitching images. Geolocation (e.g., GPS) data is also imported into the system and used to geotag vertical panoramas and match vertical panoramas to buildings. Next, from a given processed image, the average surface temperature of the building is calculated and an internal temperature of the building is inferred. Next, the building surface heat flow is calculated. The energy use of the building within a given time period (e.g., annual) is then calculated. Such information is used to calculate a raw energy score that is a function of the energy use of the building with the given time period. The raw energy score is then converted to a percentile.

A calculation of an average surface temperature of the building can be facilitated by determining threshold images by temperature, detecting leak candidates, and characterizing leak candidates. Upon making an inference of an internal temperature of the building, a consumer survey database is accessed to, in sequence, i) infer missing building data, ii) classify leaks and remove false positive, iii) infer leaks' material properties, iv) match each leak type to possible fix activities and materials, v) calculate heat flow for building surfaces and leaks, vi) virtually apply each leak fix and rerun heat flow model, vii) translate energy flow into money flow, viii) calculate the potential energy and money savings of each fix, ix) score and rank each fix by ROI, and x) identify the financially opportune fixes. Such information can then be presented to the user as part of report, as described elsewhere herein.

Systems and methods provided herein can be combined with or modified by other systems and methods, such as, for example, those described in U.S. Patent Publication No. 2009/0210192 to Askar (“METHOD OF ASSESSING ENERGY EFFICIENCY OF BUILDINGS”), U.S. Patent Publication No. 2011/0025851 to Rumble (“IMAGE ACQUISITION”), U.S. Patent Publication No. 20110106471 to Curtis et al. (“METHOD AND SYSTEM FOR DISAGGREGATING HEATING AND COOLING ENERGY USE FROM OTHER BUILDING ENERGY USE”), U.S. Patent Publication No. 2012/0310708 to Curtis et al. (“METHOD AND SYSTEM FOR SELECTING SIMILAR CONSUMERS”) and U.S. Pat. No. 8,086,042 to Fellinger (“WEATHERIZATION IMAGING SYSTEMS AND METHODS”), each of which is entirely incorporated herein by reference.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents. It is intended that the following claims define the scope of the invention and that methods and structures within the scope of these claims and their equivalents be covered thereby.

What is claimed is:

1. A method for analyzing a structure, the method comprising:
capturing a set of images of said structure in one or more ranges of wavelengths of light with an image capture device mounted on a vehicle, wherein the set of images is captured while the vehicle is moving;
processing, with the aid of a computer processor, the set of images to generate a set of image data;
combining the set of image data with a separate set of data to form a combined data set; and
analyzing the combined data set to determine one or more properties of the structure.

2. The method of claim 1, wherein the one or more properties of the structure comprises structural, heating, and energy consumption information, and determining the one or more properties comprises comparing the captured first and second set of images with a separate set of data to infer the structural, heating, and energy information.

3. The method of claim 2, wherein the structural, heating, and energy consumption information includes one or more of a presence of insulation, a type and effectiveness of the insulation, a presence of vapor barriers, a presence of baseboard heaters, wear and tear of structural features, weathering of structural features, a presence of cracks, structural integrity, a presence of gas leaks, a presence of water leaks, a presence of heat leaks, a presence of roof degradation, a presence of water damage, structural degradation, thermal emissivity, a presence or fitness of windows, a presence or fitness of roofing material, a presence or fitness of cladding, R-value, and wetness.

4. The method of claim 2, wherein the one or more properties of the structure comprises energy flux per leak, and wherein said energy flux per leak is computed based on the inferred structural, heating, and energy consumption information.

5. The method of claim 1, wherein the separate set of data comprises one or more of public geographic information service (GIS) data, private GIS data, demographic data, self-reported homeowner information, and manual energy audit information.

6. The method of claim 1, wherein the one or more properties of the structure comprises an energy consumption rate of the structure.

7. The method of claim 6, further comprising comparing with the aid of a computer processor the energy consumption rate with a second energy consumption rate of the structure from an energy audit or database containing the second energy consumption rate.

8. The method of claim 1, further comprising suggesting one or more fixes or improvements to the structure based on the determined one or more properties.

9. The method of claim 1, wherein the one or more ranges of wavelengths of light is in a range from 350 nm to 1.2 μm.

10. The method of claim 1, wherein the one or more ranges of wavelengths of light is in a range from 8 μm to 12 μm.

11. The method of claim 1, wherein the set of images comprises a first set of images and a second set of images, wherein said first set of images is captured with a first image capture element of the image capture device and a second set of images is captured with a second image capture element of the image capture device, the second image capture element being different from the first image capture element.

12. The method of claim 1, wherein the set of images comprises a plurality of still pictures of said structure at various points in time.

13. The method of claim 1, wherein the structure is one of a building, a residential building, and a commercial building.

14. The method of claim 1, wherein individual images comprising the set of images are captured simultaneously.

15. The method of claim 1, wherein the set of images is captured while the vehicle is moving adjacent to the structure.

16. The method of claim 1, further comprising directing the movement of said vehicle adjacent to said structure prior to capturing said set of images.

17. A method for analyzing a structure, the method comprising:
capturing a first set of images of said structure in a first range of wavelengths of light with an image capture device mounted on a vehicle, wherein the first set of images is captured while the vehicle is moving;
capturing a second set of images of the structure in a second range of wavelengths of light with the image capture device, wherein the second set of images is captured while the vehicle is moving; and
calculating, with the aid of a computer processor, one or more properties of the structure based at least in part on the captured first and second set of images.

18. The method of claim 17, wherein the one or more properties of the structure comprises structural, heating, and energy consumption information, and determining the one or more properties comprises comparing the captured first and second set of images with a separate set of data to infer the structural, heating, and energy information.

19. The method of claim 18, wherein the separate set of data comprises one or more of public geographic information service (GIS) data, private GIS data, demographic data, self-reported homeowner information, and manual energy audit information.

20. The method of claim 17, wherein the first set of images is captured with a first image capture element of the image capture device and the second set of images is captured with a second image capture element of the image capture device, the second image capture element being different from the first image capture element.

21. The method of claim 17, wherein the first or second set of images comprises a plurality of still pictures of said structure at various points in time.

22. The method of claim 17, wherein the first and second sets of images are captured simultaneously.

23. A system for analyzing a structure, the system comprising:
a vehicle mounted image capture device having a first image capture element for capturing a first set of images in a first wavelength range and a second image capture element for capturing a second set of images in a second wavelength range; and
a computer processor programmed to determine one or more properties of the structure based on said first and second sets of images captured by the image capture device while the vehicle is moving.

24. The system of claim 23, wherein the first wavelength range is in a range from 350 nm to 1.2 μm.

25. The system of claim 23, wherein the second wavelength range is in a range from 8 μmm to 12 μm.

26. The system of claim 23, wherein the computer processor is located remotely with respect to the vehicle mounted image capture device, and wherein the vehicle mounted image capture device comprises a communications interface for transmitting the first and second sets of captured images to the computer processor for determining said one or more properties of the structure.

27. The system of claim 23, wherein the one or more properties of the structure comprises structural, heating, and/or energy information, and wherein the computer processor is configured to determine the one or more properties of the structure by comparing the captured first and second sets of images with a separate set of data to infer the structural, heating, and/or energy information.

28. The system of claim 27, wherein the separate set of data comprises one or more of public geographic information service (GIS) data, private GIS data, demographic data, self-reported homeowner information, and manual energy audit information.

29. A system for analyzing a structure, comprising:
a vehicle mounted image capture device for capturing a set of images of said structure in one or more ranges of wavelengths of light, wherein the set of images is captured while the vehicle is moving;
a computer processor programmed to:
process the set of images to generate a set of image data;
combine the set of image data with a separate set of data to form a combined data set; and
analyze the combined data set to determine one or more properties of the structure.
